(19) United States
(12) Patent Application Publication
(10) Pub. No.: US 2009/0307274 A1
(43) Pub. Date: Dec. 10, 2009

(54) DELAYED MERGE

(75) Inventor: Peter Baer, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/134,202

(22) Filed: Jun. 6, 2008

(51) Int. Cl. G06F 17/30

(52) U.S. Cl. 707/201; 707/E17.044

(57) ABSTRACT

Various technologies and techniques are disclosed for performing delayed merge operations. A copy of a master version of a document is retrieved from a server. User changes to the copy of the document are received through a client application. When changes have occurred to the master version of the document since user changes were made to the copy of the document, a merge operation needs performed. When the client application is ready to perform a merge operation upon saving changes to the server, then the merge operation is performed to the master version of the document on the server. When the client application is not ready to perform the merge operation, then information regarding changes made to the copy of the document by the client application is saved to the server for later merging by a separate delayed merge operation performed by one or more peers.

### BACKGROUND

Software applications such as MICROSOFT® OneNote allow a single document to be edited off-line and simultaneously by multiple client applications. When a revised version of a document is uploaded to the shared server by a client application, any merges must typically be resolved at that point in time when the changed version is being uploaded. This typically requires each client to perform a merge of its own changes with any changes that may have occurred on a shared server before those changes can be committed. Depending on the document format, a merge operation can be an expensive investment for the client application in terms of software development complexity, or runtime performance, or both.

### SUMMARY

Various technologies and techniques are disclosed for performing delayed merge operations. A copy of a master version of a document is retrieved from a server. User changes to the copy of the document are received through a client application. When new changes have occurred to the master version of the document since user changes were made to the copy of the document, a merge operation needs performed. When the client application is ready to perform a merge operation upon saving changes to the server, then the merge operation is performed to the master version of the document on the server. When the client application is not ready to perform the merge operation upon saving changes to the server, then information regarding changes made to the copy of the document by the client application is saved to the server for later merging by a separate delayed merge operation performed by one or more peers.

In one implementation, techniques are described for performing a delayed merge operation. A current server master version of a document is checked to determine that a merge operation needs performed. Delayed merge information is retrieved for the document, the delayed merge information containing details regarding changes made by a client application that need merged into the current server master version of the document. The merge operation is performed to create a new merged document. The current server master version of the document is replaced with the new merged document.

In one implementation, a data format for storing a document along with delayed merge information is described. The data format includes a document structure, a delayed merge structure, and a header structure. The document structure is operable to store multiple instances of an application-specific document format. The delayed merge structure is operable to point to a beginning of a branch document, to point to a beginning of a base document, and to point to a next delayed merge structure. The header structure is operable to point to a beginning section of a master version of the document, and to point to a beginning section of the delayed merge structure.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a process flow diagram for one implementation illustrating the high level stages involved in performing a merge operation based upon changes made by a client application.

FIG. 2 is a process flow diagram for one implementation illustrating the stages involved in changing the document through a client application.

FIG. 3 is a process flow diagram for one implementation illustrating the more detailed stages involved in performing a merge operation based upon changes made by a client application.

FIG. 4 is a process flow diagram for one implementation illustrating the stages involved in performing a delayed merge operation by one or more peers.

FIG. 5 is a diagrammatic view of an exemplary data format for storing the master version of the document along with delayed merge information needed to perform the delayed merge operation.

FIG. 6 is a process flow diagram for one implementation illustrating the stages involved in saving delayed merge information to the master version of the document according to the exemplary structure of FIG. 5.

FIG. 7 is a process flow diagram for one implementation that illustrates the stages involved in performing a delayed merge operation by utilizing the delayed merge information stored according to the exemplary structure of FIG. 5.

FIG. 8 is a diagrammatic view of a computer system of one implementation.

### DETAILED DESCRIPTION

The technologies and techniques herein may be described in the general context as an application that enables delayed merge operations, but the technologies and techniques also serve other purposes in addition to these. In one implementation, one or more of the techniques described herein can be implemented as features within a word processing program such as MICROSOFT® OneNote, or from any other type of program or service that manages server-based versions of documents. In another implementation, one or more of the techniques described herein are implemented as features with other applications that deal with merging changes made to the same document by multiple client applications.

In one implementation, techniques are described for enabling the storage of multiple, unmerged client changes to a document to a shared server document. The multiple, unmerged client changes in the shared server document can then later be lazily and independently merged into the master version of the document by other clients or server processes.

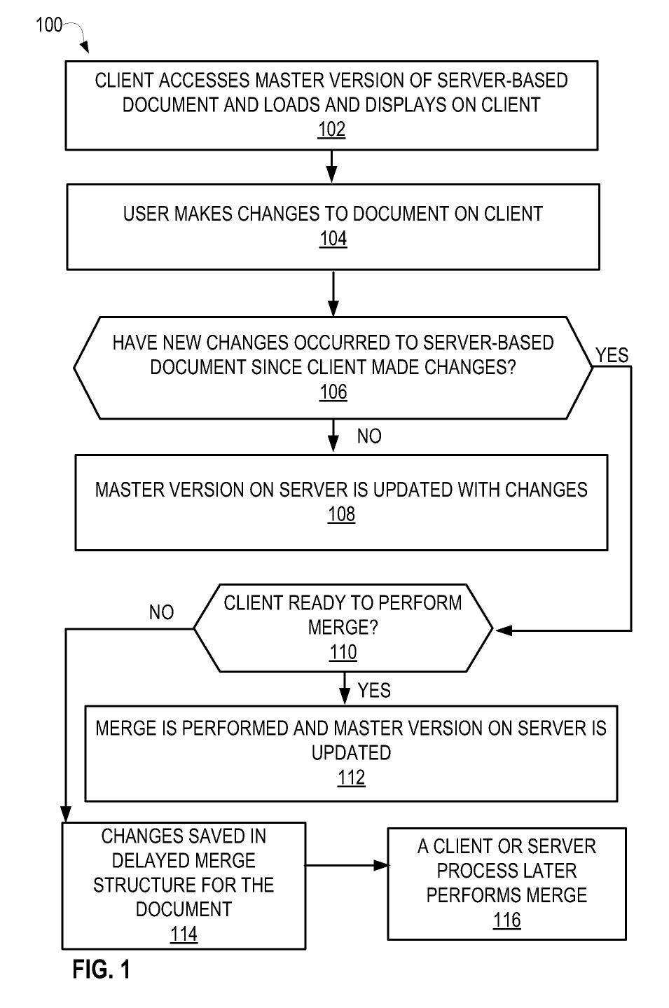

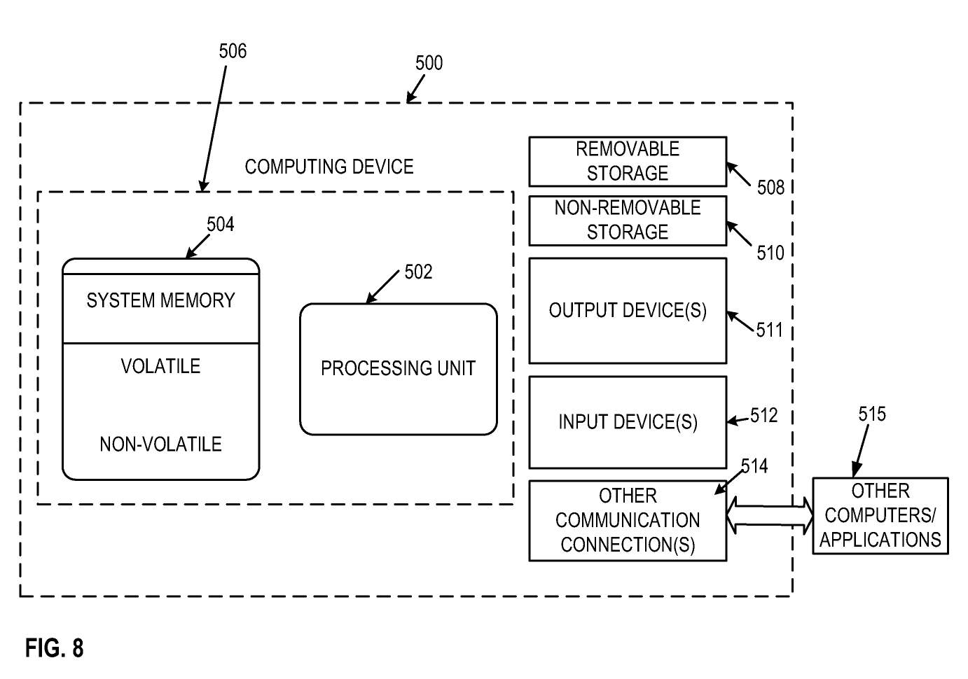

Turning now to FIGS. 1-7, the stages for implementing one or more implementations of a delayed merge system are described in further detail. In some implementations, the processes of FIG. 1-7 are at least partially implemented in the operating logic of computing device 500 (of FIG. 8).

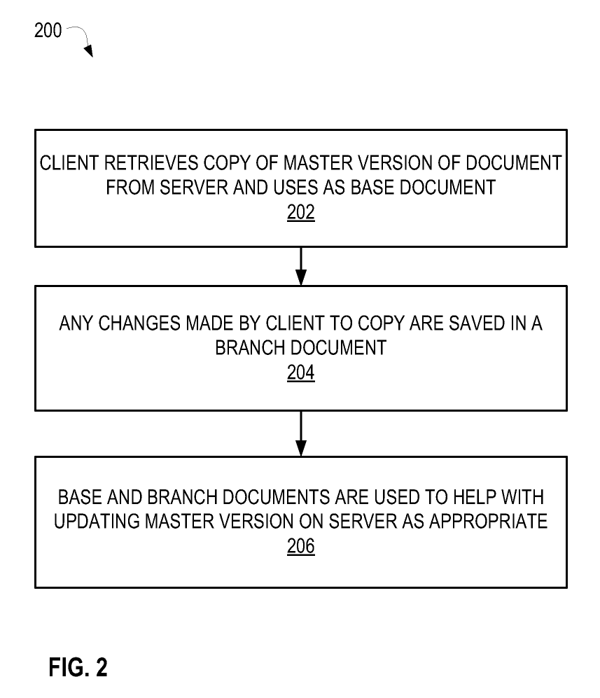

FIG. 1 is a process flow diagram 100 for one implementation illustrating the high level stages involved in performing a merge operation based upon changes made by a client application. A client application accesses a master version of a server-based document and loads and displays the document on the client (stage 102). The user makes changes to the document using the client application (stage 104). FIG. 2 describes one example of how changes made by the user are tracked by the client application. At the point that the client application is ready to submit changes to the server, if new changes have not occurred to the server-based document since the client made changes (decision point 106), then the master version of the document on the server is updated with the changes (stage 108). In one implementation, the master version on the server is updated with changes by simply replacing the master version of the document with the changed version of the document from the client. In another implementation, the master version is actually updated with changes that were made on the client.

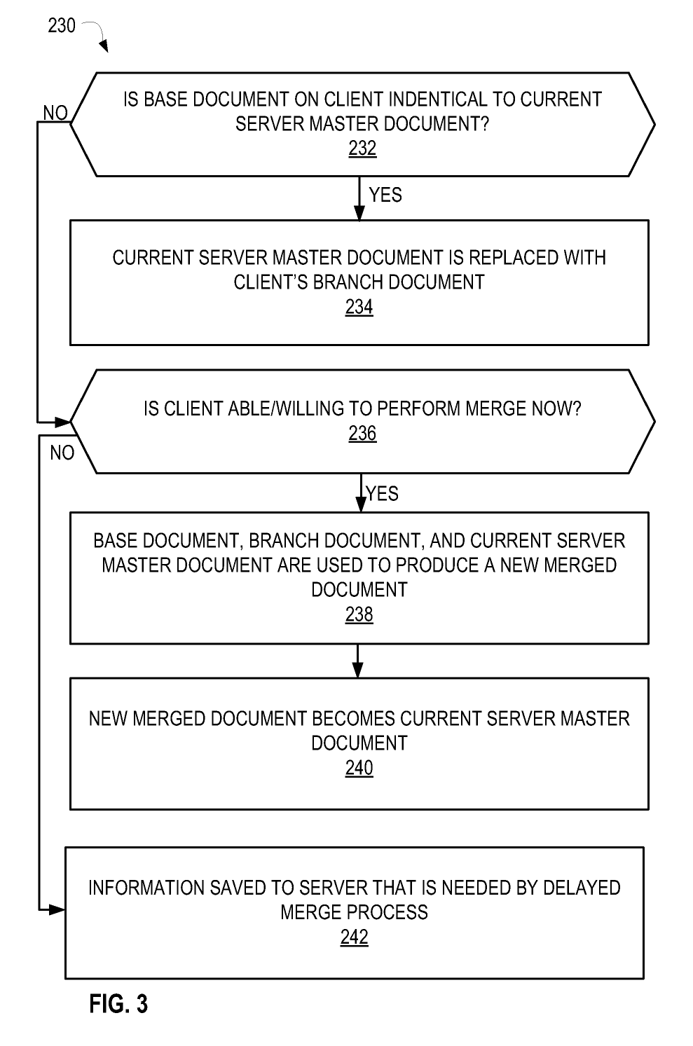

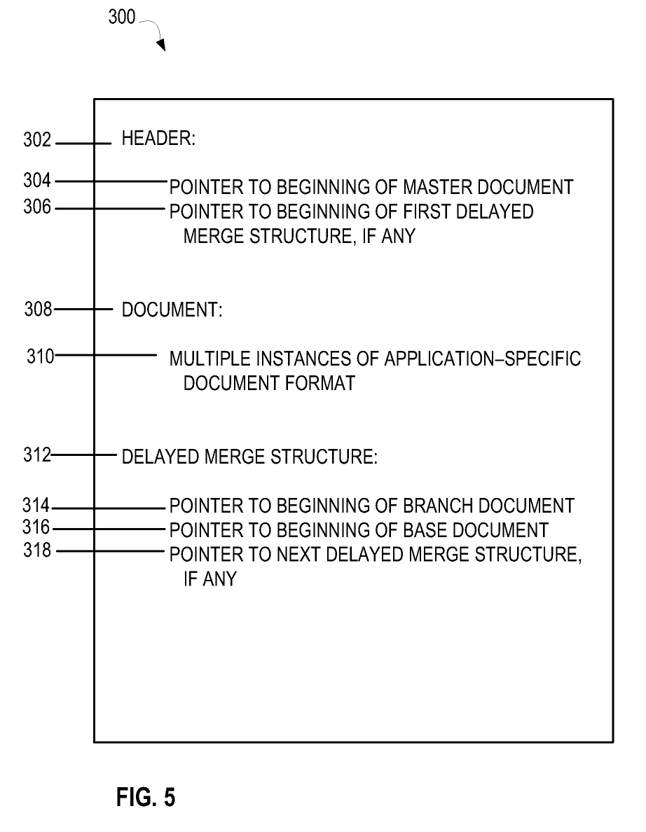

If new changes have occurred to the server-based document since the client made changes (decision point 106), then the client is prompted to either perform the merge or to delay the merge for later. In other words, since someone else has modified the master version of the document since the current client application started making changes, these changes will need to be reconciled through a merge operation. If the client is ready and able to perform the merge operation (decision point 110), then the merge is performed and the master version on the server is then updated (stage 112). The process of having the client go ahead and perform the merge operation upon saving changes to the server is described in more detail in FIG. 3. If the client is not ready or able to perform the merge (decision point 110), then the changes are saved in a delayed merge structure for the document (stage 114). In one implementation, at least a portion of the delayed merge information is saved within the master version of the document on the server. An example of a document format that can be used for storing delayed merge information within the master version of the document is described in FIG. 5. In another implementation, the delayed merge information is saved in one or more separate locations or files from the master version of the document on the server.

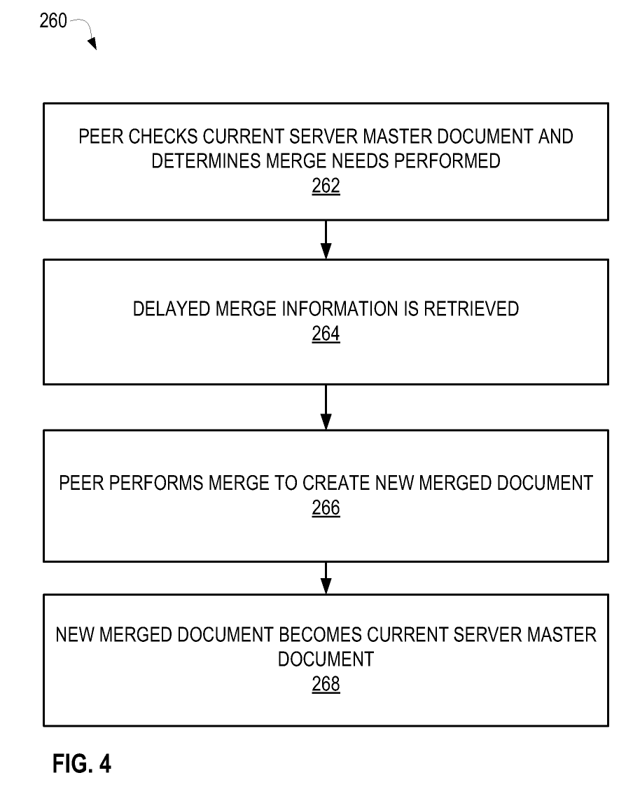

Once the delayed merge information is saved, a client or server process that is a peer to the client application then later performs the merge (stage 116). The peer that later performs the delayed merge can include one or more separate computers or the same computer as the client application that originally made the changes. In other words, one or more peer processes that have processing availability later or are otherwise willing to assist with delayed merges will pick up the processing at a later time. In some instances, the same computer that originally made the changes may be one that ends up participating in the delayed merge at a later time. But in other instances, the delayed merge may be performed by one or more totally separate computers than the one that originally made the changes that need merged. In one implementation, a delayed merge operation allows computers that have the resources (such as memory, network connection speed, or otherwise) to assist with performing the merge, while other computers that do not have the resources can still save changes, but have their changes merged by another computer. More details on some exemplary delayed merge operations are described in further detail in FIGS. 4-7.

FIG. 2 is a process flow diagram 200 for one implementation illustrating the stages involved in changing the document through a client application. A client application retrieves a copy of a master version of a document from a server and uses the copy as a base document (stage 202). Any user changes that are made by the client application to the copy of the document are saved in a branch document (stage 204). The base document and branch document are used to help with updating the master version of the document on the server as appropriate (stage 206).

FIG. 3 is a process flow diagram 230 for one implementation illustrating the more detailed stages involved in performing a merge operation based upon changes made by a client application. If the base document on a client is identical to the current server master version of the document (decision point 232), then the current server master version of the document is replaced with the client application's branch document (stage 234). If the base document of the client application is not identical to the current server master document (decision point 232), then the client application is prompted to indicate whether it is willing or able to perform the merge now (decision point 236). If the client application indicates that it is willing or able to perform the merge now (decision point 236), then the base document, branch document, and current server master document are used to produce a new merged document (stage 238). The new merged document then becomes this current server master document (stage 240) by replacing the file or using another suitable process.

If the client is not able or willing to perform the merge now (decision point 236), then the information is saved to the server that is needed by the delayed merge operation (stage 242).

FIG. 4 is a process flow diagram 260 for one implementation illustrating the high level stages involved in performing a delayed merge operation by one or more peers. As described earlier in FIG. 1, the peer that performs the delayed merge can include one or more separate computers or the same computer as the client application that originally made the changes. In other words, one or more peer processes that have processing available later or are otherwise willing to assist with delayed merges will pick up the processing at a later time.

At the appropriate point in time, one or more peer processes checks the current server master document to determine if a merge needs to be performed (stage 262). In other words, the peer checks to see if there are unmerged changes that need to be merged into the master version of the document. The point in time at which one or more peers perform this check can be whenever the peer is saving its own changes to the server, whenever the peer has idle processing time, or at any other time that the peer wishes to assist. If there have been unmerged changes detected by the peer, then the delayed merge information is retrieved for the current server master document (stage 264) so the peer can perform the merge operation. In one implementation, the delayed merge information is retrieved from within the current server master document. In another implementation, the delayed merge information is retrieved from a separate document than the current server master document. The peer then performs the merge operation to create the new merged document (stage 266). The new merged document becomes this current server master document (stage 268).

Some more detailed examples of an exemplary delayed merge structure and delayed merge operation will now be provided in the discussion of FIGS. 5-7, but it should be appreciated that these are just provided for the sake of example, and that other variations in data structure and processes could also be utilized for performing delayed merge operations.

FIG. 5 is a diagrammatic view of an exemplary data format 300 for storing a master version of the document along with delayed merge information needed to perform the delayed merge operation. The exemplary data format 300 includes a header structure 302, a document structure 308, and a delayed merge structure 312. The header structure 302 contains a pointer to the beginning of the master document 304, which is a pointer to the actual data contents of the overall document that was opened. Header structure 302 also includes a pointer to the beginning of the first delayed merge structure 306, if any. In one implementation, this value is zero if no delayed merge structures are present in the file, but other values could be used to indicate the presence or absence of delayed merge structures.

The document structure 308 contains multiple instances of an application-specific document format 310. For example, if the master document is a MICROSOFT® OneNote document, then there may be multiple versions of a OneNote document contained in document structure 308. These multiple versions can include the content of the master version itself, content from Client A, content from Client B, and so on. In one implementation, the different versions of the file that need merged together are contained somewhere in the file, but do not have to be in any particular location or section of the file. In such a scenario, the documents can be located through one or more reference pointers (such as pointers 304, 314, and 316, discussed herein). In other words, the term document structure 308 as used herein is simply referring to a logical concept of storing the different versions of the document, and is not meant to imply that any type of ordering or physical location is required. In an alternate implementation, a specific order and/or location in the file could also be used for storing the instances of the documents that need merged together.

The delayed merge structure 312 contains a pointer to the beginning of the branch document 314, which is the latest version from a particular client application with its changes. The delayed merge structure 312 also includes a pointer to the beginning of the base document 316, which is the original version that a particular client application retrieved when it started making changes. The delayed merge structure 312 also includes a pointer to the next delayed merge structure 318, if any. In one implementation, zero is used to indicate if the current structure is the last structure, but other values could also be used. There can be multiple delayed merge structures 312 if there are multiple versions of the document from different client applications that need merged together.

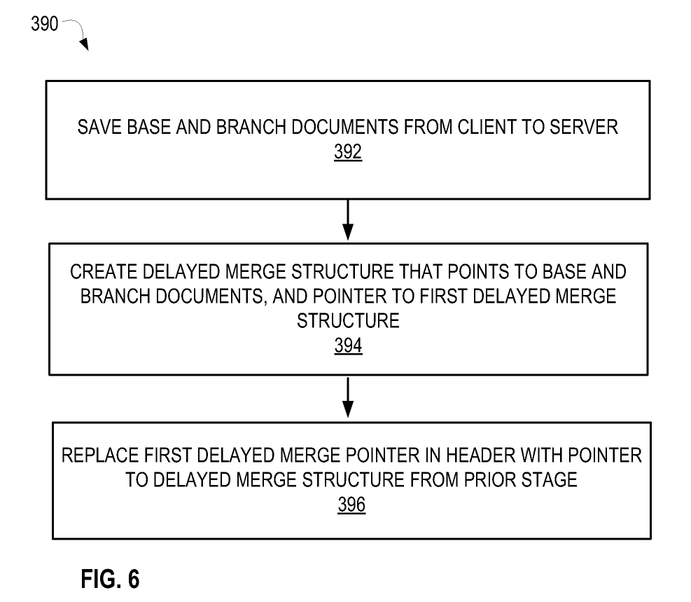

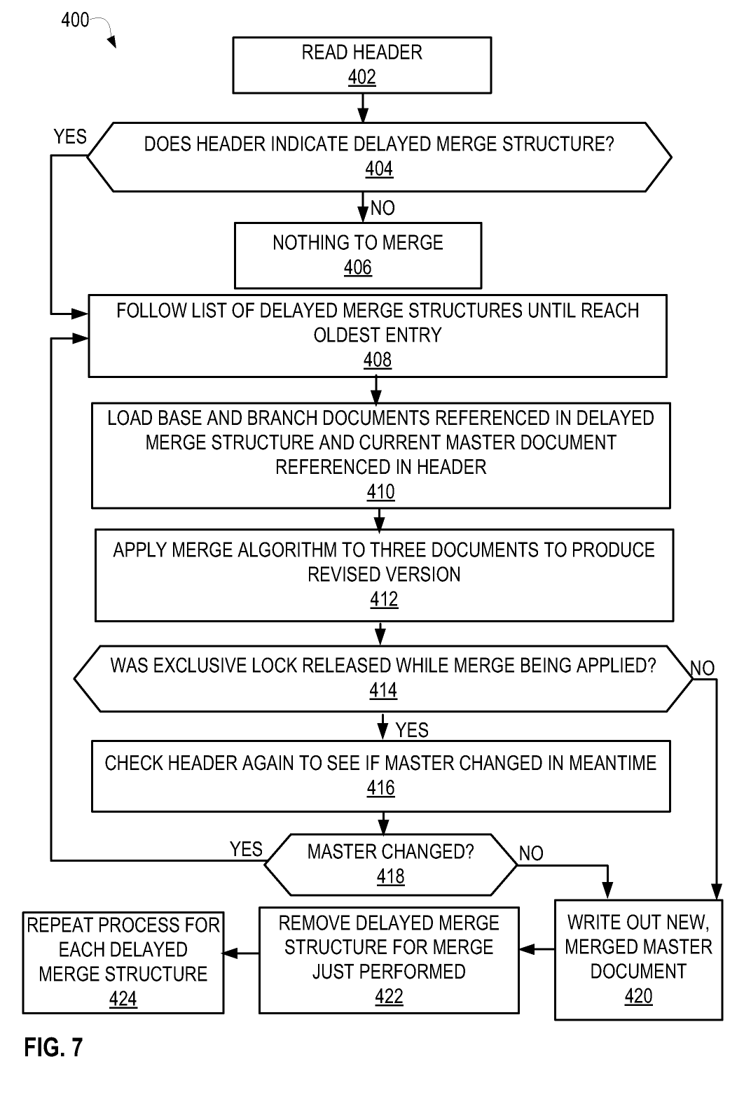

FIG. 6 is a process flow diagram 390 for one implementation illustrating the stages involved in saving delayed merge information to the master version of the document according to the exemplary structure of FIG. 5. When a client application decides to delay a merge operation for later, the base and branch documents are saved from the client to the server (stage 392). In one implementation, the base and branch documents are saved to the server by appending them to the end of the master version of the document. The delayed merge structure is created with pointers to the base and branch documents, and a pointer to the first delayed merge structure (e.g. as read from the header) (stage 394). The first delayed merge pointer in the header is replaced with the pointer to the delayed merge structure from the prior stage (stage 396). In other words, this makes the newly written delayed merge structure the first one in the list. Now that the delayed merge information has been saved, one or more peers can later access the delayed merge information when they are ready to actually perform the merge. This process is described in greater detail in FIG. 7.

FIG. 7 is a process flow diagram 400 for one implementation that illustrates the stages involved in performing a delayed merge operation by utilizing the delayed merge information previously stored according to the exemplary structure of FIG. 5. As described in earlier figures, one or more peers can initiate the delayed merge operation at one of various points in time, such as when submitting their own changes to the server or when their processing resources allow, to name a few non-limiting examples. Peers can use various types of logic to make a decision that it is time to perform a delayed merge operation. When a peer does decide to perform a delayed merge operation, it can execute the stages described in FIG. 7.

The header of the master version of the file is read (stage 402) to see if the presence of a delayed merge structure is indicated (decision point 404). In one implementation, the absence of a delayed merge structure is indicated by a zero pointer to the first delayed merge structure. If the header does not indicates the presence of a delayed merge structure (decision point 404), then there is nothing to merge (stage 406) and the process ends. If the header does indicate the presence of the delayed merge structure (decision point 404), then the list of delayed merge structures is followed until the oldest (i.e. last) entry is reached (stage 408). The base and branch documents that are referenced in the delayed merge structure are loaded, and the current master document referenced in the header is also loaded (stage 410). A merge algorithm is applied to these three documents (base, branch, and master) to produce a revised version (stage 412). In other words, the changes are merged between the base, branch, and master using one of many known document merging techniques.

In one implementation, if an exclusive lock was released while the merge was being applied (decision point 414), then the header is checked again to see if the master document changed in the meantime (stage 416). Such a change could be due to another peer performing the same delayed merge, or simply another change happening to the master. If the master has changed in the meantime (decision point 418), then the process repeats by looking for the next oldest entry in the delayed merge structure (stage 408), but abandoning the work done so far.

If an exclusive lock was not released while the merge was being applied (decision point 414), or if an exclusive lock was released but the master did not change in the meantime (decision point 418), then the new, merged master document is written out (stage 420). The delayed merge structure is removed for the merge that was just performed (stage 422). In one implementation, this is performed by setting the pointer on the previous delayed merge structure to be the same as its own next delayed merge pointer, which is likely zero. The process is then repeated for each delayed merge structure in the document (stage 424), with processing continuing for the next oldest delayed merge structure, and so on until they are all processed.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for merging changes made by a client application with a master version on a server comprising the steps of:
retrieving a copy of a master version of a document from a server;
receiving user changes to the copy of the document through a client application;
when new changes have occurred to the master version of the document since user changes were made to the copy of the document, determining that a merge operation needs performed;
when the client application is ready to perform a merge operation upon saving changes to the server, then performing the merge operation to the master version of the document on the server; and
when the client application is not ready to perform the merge operation upon saving changes to the server, then saving information regarding changes made to the copy of the document by the client application to the server for later merging by a separate delayed merge operation.

2. The method of claim 1, wherein the copy is saved in a base document.

3. The method of claim 2, wherein when user changes are made, the user changes are saved in a branch document.

4. The method of claim 3, wherein the saving information step comprises the steps of saving the base document and the branch document to the server.

5. The method of claim 4, wherein the saving information step further comprises the steps of creating a delayed merge structure in the master version of the document that points to the base document and the branch document.

6. The method of claim 5, wherein the saving information step further comprises the steps of replacing a first delayed merge pointer in a header of the master version of the document with a pointer to the delayed merge structure.

7. The method of claim 1, wherein the merge operation is responsible for merging any changes made by the client application with the master version of the document on the server.

8. The method of claim 1, wherein the separate delayed merge operation is performed by a peer.

9. The method of claim 8, wherein the separate delayed merge operation is performed by the peer when the peer has processing availability.

10. The method of claim 8, wherein the peer is another client application.

11. The method of claim 8, wherein the peer is the server.

12. A method for performing a delayed merge comprising the steps of:
checking a current server master version of a document and determining that a merge operation needs performed;
retrieving delayed merge information for the document, the delayed merge information containing details regarding changes made by a client application that need merged into the current server master version of the document;
performing the merge operation to create a new merged document; and
replacing the current server master version of the document with the new merged document.

13. The method of claim 12, wherein the merge operation is performed by a peer of the client application that originally made changes to the document.

14. The method of claim 12, wherein at least a portion of the delayed merge information is stored in a delayed merge structure within the current server master version of the document.

15. The method of claim 12, wherein at least a portion of the delayed merge information is stored in a separate file from the current server master version of the document.

16. The method of claim 12, wherein the delayed merge information includes a base document and a branch document.

17. The method of claim 16, wherein the delayed merge information further includes a delayed merge structure that points to the base document and the branch document.

18. A computer-readable medium having computer-executable components comprising:
a document structure in a document, the document structure being operable to store multiple instances of an application-specific document format;
a delayed merge structure in the document, the delayed merge structure being operable to point to a beginning of a branch document, to point to a beginning of a base document, and to point to a next delayed merge structure; and
a header structure in the document, the header structure being operable to point to a beginning section of a master version of the document, and to point to a beginning section of the delayed merge structure.

19. The computer-readable medium of claim 18, wherein the document structure, the delayed merge structure, and the header structure is operable to be utilized by peer when performing a delayed merge operation.

20. The computer-readable medium of claim 19, wherein the delayed merge operation is operable to merge changes made to the document by a client application into a master version of the document on a server.
